(19) United States
(12) Patent Application Publication
(10) Pub. No.: US 2001/0040585 A1
(43) Pub. Date: Nov. 15, 2001

(54) RESIZING MULTI-DIMENSIONALLY RENDERED GRAPHICAL IMAGES

(76) Inventors: STEPHEN A HARTFORD, FOLSOM, CA (US); MICHAEL RICHARD YOUNG MOORE, RANCHO CORDOVA, CA (US); J PAUL MONTGOMERY, GRANITE BAY, CA (US); ROBERT J HOOPER, FAIR OAKS, CA (US); TODD K SPRAGUE, RANCHO CORDOVA, CA (US)

Correspondence Address: JOHN S FERRELL, CARR & FERRELL, SUITE 200, 2225 EAST BAYSHORE ROAD, PALO ALTO, CA, 94303

(21) Appl. No.: 09/135,754

(22) Filed: Aug. 18, 1998

(51) Int. Cl. G09G 5/00

(52) U.S. Cl. 345/667

(57) ABSTRACT

A method is disclosed for resizing multi-dimensionally rendered graphical images. A first step in the method divides a graphical image into a plurality of predefined resizable and non-resizable sections. A second step in the method further divides the resizable sections into a plurality of stretch areas. A third step in the method divides each stretch area into a cell matrix. A fourth step in the method resizes the graphical image by duplicating or removing a row or column of matrix cells in one or more of the stretch areas.

### BACKGROUND OF THE INVENTION

1. Field of the Invention

The present invention relates generally to methods for rendering graphical images, and more particularly for resizing multi-dimensionally rendered graphical images.

2. Discussion of Background Art

Today, most modern computers commonly display information and solicit input from users through graphically generated dialog boxes or windows. As computers and software applications have increased in sophistication, a need has been created for ever more complex and user friendly dialog graphics. In response to this need, many computers now display highly ornamental threedimensional dialog windows which not only meet the functional needs of a particular software application, but also provide a user with an aesthetically pleasing interface. Most recently three-dimensional graphics have been added to dialog windows, further increasing their realism.

Unfortunately, as the complexity of these graphical dialog windows has heightened, the difficulty of manipulating and resizing them has also increased. Currently, dialog windows containing even a few features and contours must be completely re-rendered each time they are resized by a user. If the graphical window is not re-rendered, dramatic changes in shading, lighting effects, and proportion may occur. Completely re-rendering a computer graphic, such as a dialog window, is a very computationally intensive process which creates an irritatingly noticeable visual stutter on a display monitor. Sophisticated computer users find such discontinuities increasingly intolerable and are thus receptive to a solution to this problem.

In response to the concerns discussed above, what is needed is a method for resizing three dimensionally rendered graphical images that overcomes the problems of the prior art.

### SUMMARY OF THE INVENTION

The present invention is a method for resizing multi-dimensionally rendered graphical images. These graphical images are preferably in either two or three dimensions. Within the method of the present invention, graphical images are provided with a plurality of predefined resizable and non-resizable sections. The resizable sections enable the image to be enlarged without needing to re-render the graphical image. There are both horizontal and vertical resizable sections. The resizable sections are further divided into a plurality of stretch areas. Each stretch area is further divided into a cell matrix. A portion of a graphical image contained within a stretch area is increased in size by duplicating either a row or column of matrix cells and inserting the row or column into the stretch area. During the duplication process, partial cells may be added to reduce any user-noticeable discontinuities when either a row or column of full size matrix cells is added. A partial cell is a predefined portion of a full size cell.

These and other aspects of the invention will be recognized by those skilled in the art upon review of the detailed description, drawings, and claims set forth below.

### BRIEF DESCRIPTION OF THE DRAWINGS

FIG. 1 is a graphical depiction of a three-dimensional, computer-generated graphic;

FIG. 2 is a graphical depiction of the graphic after resizing in a vertical direction;

FIG. 3 is a graphical depiction of the graphic after resizing in a horizontal direction;

FIG. 4 is a graphical depiction of the graphic including a more detailed vertical resizable section;

FIG. 5 is a graphical depiction of a vertical stretch area within the vertical resizable section;

FIG. 6 is a graphical depiction the vertical stretch area after stretching, as shown in FIG. 2;

FIG. 7 is a graphical depiction of the vertical stretch area containing a partial vertical row;

FIG. 8 is a graphical depiction of the graphic including a more detailed horizontal resizable section;

FIG. 9 is a graphical depiction of a horizontal stretch area within the horizontal resizable section;

FIG. 10 is a graphical depiction the horizontal stretch area after stretching, as shown in FIG. 3;

FIG. 11 is a graphical depiction of the horizontal stretch area containing a partial horizontal column;

FIG. 12 is a flowchart for defining stretch areas in multi-dimensionally rendered graphical images; and

FIG. 13 is a flowchart for resizing multi-dimensionally rendered graphical images.

### DETAILED DESCRIPTION OF THE PREFERRED EMBODIMENT

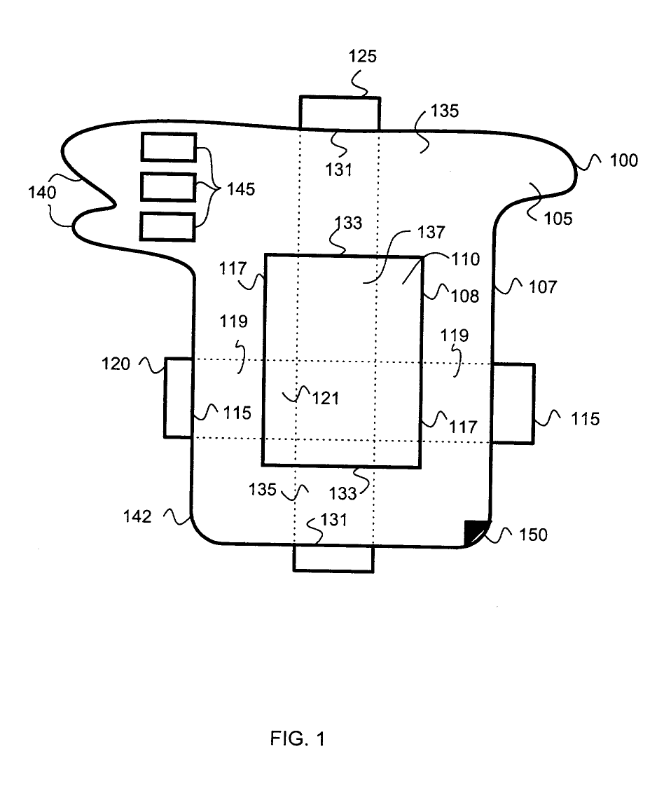

FIG. 1 is a graphical depiction of a three-dimensional, computer-generated graphic 100. The graphic 100 is a computer object and is preferably produced using a conventional computer drawing program and rendered to produce a visually realistic, two-dimensional or three-dimensional image.

The drawing program preferably operates on a conventionally known computer system (not shown). The computer system includes an internal memory for storing computer program instructions which control how a processing unit within the computer accesses, transforms and outputs data. The internal memory includes both a volatile and a non-volatile portion. Those skilled in the art will recognize that the internal memory could be supplemented with other computer useable storage media, including a compact disk, a magnetic drive or a dynamic random access memory.

The rendering process involves creating a two-dimensional or three-dimensional geometry, applying surface descriptions and computer generating a final image. The time interval during which the final image is generated will be referred to as an image update interval.

The graphic 100 preferably provides a graphical, dialog-window type of interface to a user within a computer environment. The graphic 100 enables the user to receive text messages or other information on a computer display (not shown) and to interact with elements of the graphic to control operations of the computer. The graphic 100 is preferably a complex text frame object consisting of a rendered, three-dimensional frame element 105 that circumscribes a text region 110. The frame element 105 includes an outer boundary 107 which defines an outer perimeter of the graphic 100, and an inner boundary 108 which defines an inner perimeter of the frame element 105. The inner boundary 108 separates the frame element 105 from the text region 110. The text region 110 is a resizable area for displaying text. In contrast to the frame element 105 which is rendered and highly ornamental, the text region 110 is preferably plain and white in appearance and provides a background for any text. The graphic 100 is preferably resizable. Both the frame element 105 and the text region 110 can be simultaneously resized thereby adjusting an amount of text that can be read at one time. Also, since the text region 110 can be enlarged, the font size of the text can be increased without reducing the amount of text displayed by the graphic 100.

The frame element 105 further includes a plurality of graphic features 145. These features 145 may be purely ornamental elements, such as logos, or they may be functional elements, such as display windows, buttons, dials, switches and the like. In addition to the features 145, the frame element 105 contains various contours 140. While contours 140 are required at each corner 142 of the frame element 105, additional contours can enhance the functional and artistic characteristics of the graphic 100.

Currently, the features 145 and contours 140 on the graphic 100 must be completely re-rendered when the graphic 100 is resized in order to preserve the graphic's 100 visual integrity. Without re-rendering, merely stretching the contour 140 may dramatically change various shading and lighting attributes of the graphic 100. Since re-rendering is a very time consuming and computation intensive process, resizable sections 120 and 125 are added. The resizable sections 120 and 125 enable the graphic 100 to be enlarged or re-shaped without otherwise affecting the graphic's 100 attributes. Where and how the resizable sections 120 and 125 are preferably incorporated into various graphic designs is demonstrated in the examples that follow.

Resizable section 120 can be visualized as a box that horizontally traverses a lower half of the graphic 100, and includes portions of the frame element 105 and part of a text region 121. The portions of frame element 105 contained within the resizable section 120 are frame legs 119. The frame legs 119 include an inner boundary 117 and an outer boundary 115.

A second resizable section 125 vertically traverses a middle portion of the graphic 100. Resizable section 125 includes frame legs 135 and a text region 137. The frame legs 135 include an inner boundary 133 and an outer boundary 131.

An advantageous characteristic of the present invention is the ability to resize the graphic 100 without re-rendering thereby decreasing the image update interval. Re-sizing the graphic 100 is effected by a resize handle 150. The resize handle 150 is a user interface icon that is activated when the graphic 100 is selected using a mouse point and click operation. Once the resize handle 150 is activated, a mouse cursor (not shown) is placed on the resize handle 150 and the handle is dragged either horizontally, vertically or diagonally until the graphic 100 is proportioned and shaped to a desired size. While the handle is being dragged, one or more image update intervals will occur during which the graphic 100 will be updated. When the desired size is achieved, the mouse cursor deselects the resize handle 150 and the graphic 100 is locked until a further resizing operation is performed. Stretching the resizable sections 120 and 125 affects the resizing operation. The resizable sections 120 and 125 preferably have a minimum size, and therefore, although the graphic 100 can be stretched to produce a larger graphic, the graphic 100 cannot be reduced in size beyond a predetermined point.

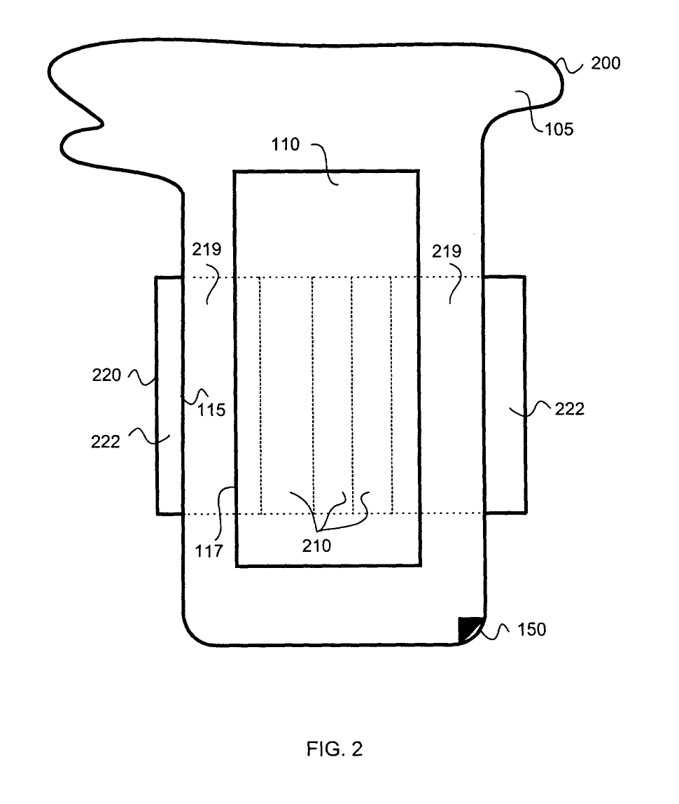

FIG. 2 is a graphical depiction of the graphic 100 after resizing in the vertical direction. This vertically resized graphic 100 is now referred to as graphic 200. Selecting the resize handle 150 and dragging the handle down in the vertical direction produces the graphic 200. This resizing process results in an increase in the vertical dimension of the graphic 100 without resizing the graphic in the horizontal direction. Graphic 200 of FIG. 2 shows a resizable section 220 that contains a section of the frame element 105 and a portion of the text region 110. Resizable section 220 is further divided into five stretch area sections designated by reference numbers 210 and 222. Stretch areas 222 are associated with the two frame legs 219, and contain the outer boundary 115 and the inner boundary 117 of the frame element 105. Stretch areas 210 are defined within the text region 110. Those skilled in the art will recognize that although the resizable section 220 is divided into five stretch areas 210 and 222, a greater or lesser number of stretch areas 210 and 222 can alternatively be used.

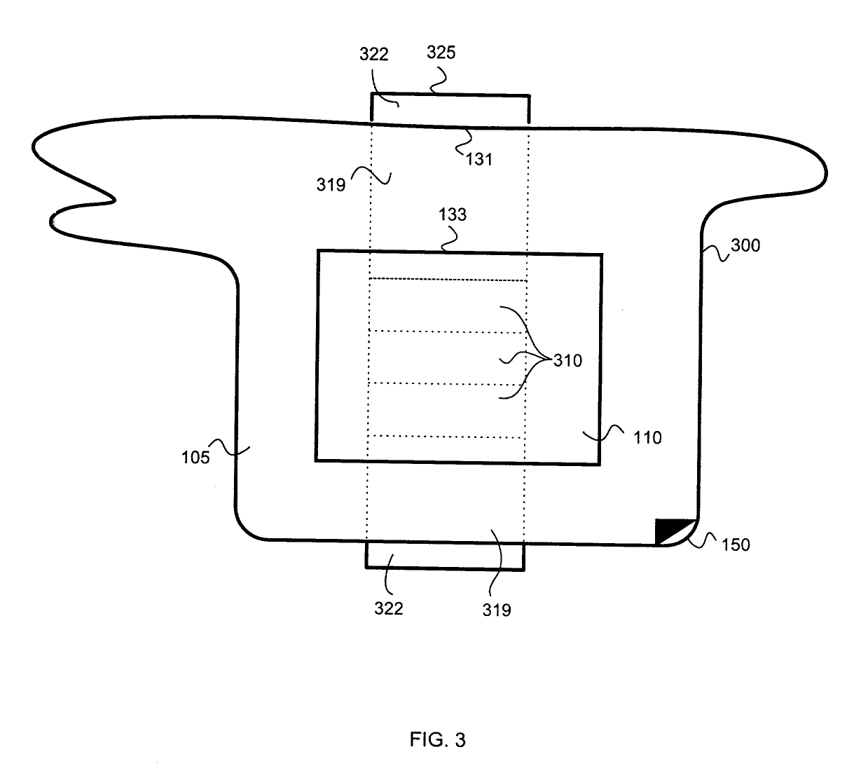

FIG. 3 is a graphical depiction of the graphic 100 after resizing in a horizontal direction. This horizontally resized graphic 100 is designated graphic 300. In a manner similar to the vertical resizing of graphic 100 to produce graphic 200 (FIG. 2), graphic 300 was produced by selecting the resize handle 150 and dragging the handle to the right in the horizontal direction. This horizontal resizing process increases a horizontal dimension of the graphic 100 without resizing the graphic in the vertical direction. Graphic 300 of FIG. 3 shows a resizable section 325 that contains a portion of the frame element 105 and a portion of the text region 110. Resizable section 325 is further divided into five stretch area sections 310 and 322. Stretch areas 322 are the stretch areas enclosing a portion of frame legs 319. Frame legs 319 contain outer boundaries 131 and inner boundaries 133. Stretch areas 310 contain the text region 110. As with graphic 200, although the resizable section 325 is divided into five stretch areas 310 and 322, a greater or lesser number of stretch areas can also be used for resizing of the graphic object 300.

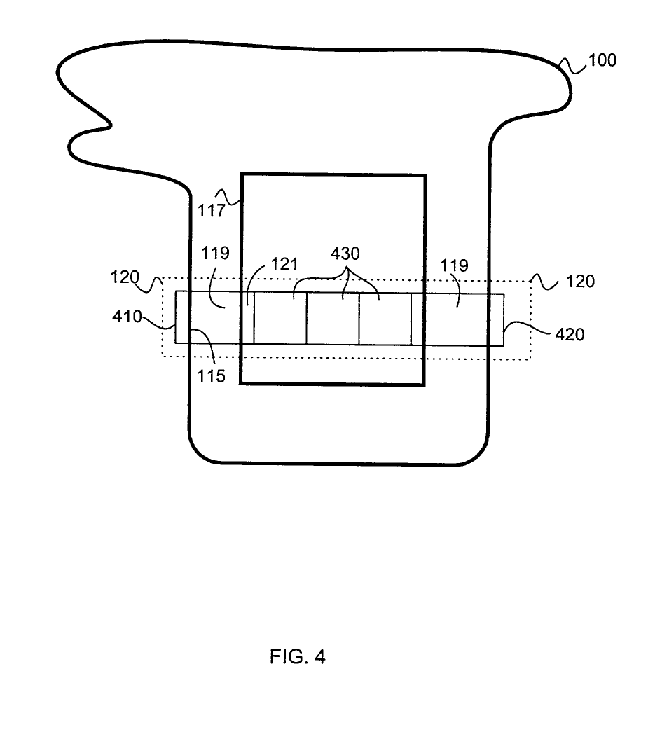

FIG. 4 is a graphical depiction of the graphic 100 including a more detailed vertical resizable section 120. Vertical resizable section 120 is divided into five vertical stretch areas 410, 420 and 430. Vertical stretch area 410 contains one of the frame legs 119. Vertical stretch areas 430 are in a minimum size configuration and may be compared with stretch areas 210 in FIG. 2, which are in an expanded configuration. Vertical stretch areas 430 contain the text region 121. Vertical resizable section 120 further contains vertical stretch area 420 that contains the other of the frame legs 119.

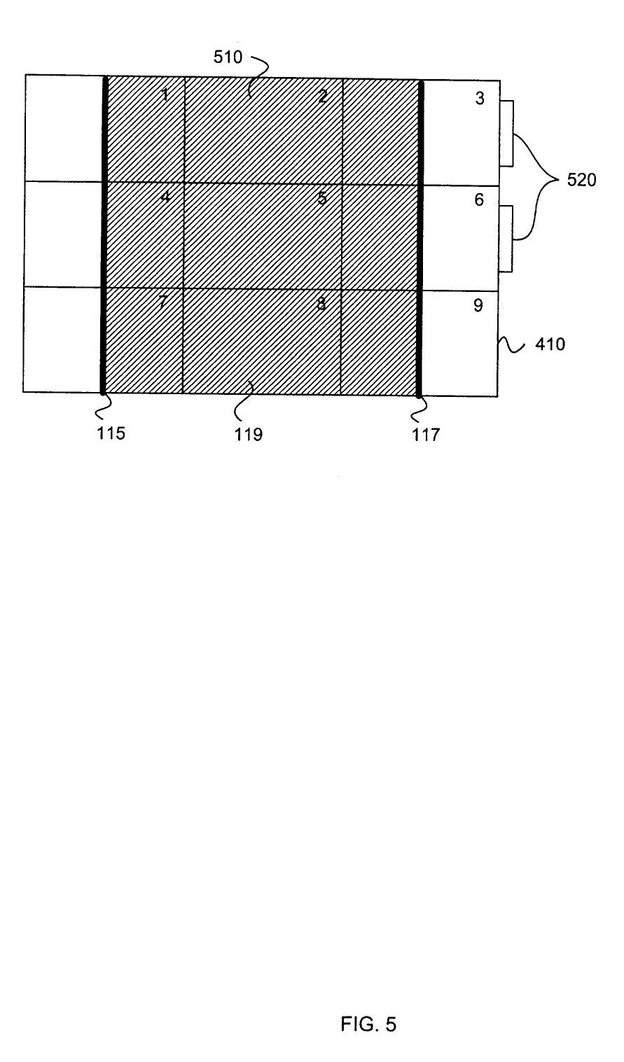

FIG. 5 is a graphical depiction of the vertical stretch area 410 within the vertical resizable section 120. Vertical stretch area 410 remains in the minimum size configuration and has not yet been stretched. Vertical stretch area 410 still includes frame leg 119 and its related outer boundary 115 and inner boundary 117. Vertical stretch area 410 is preferably divided into a matrix of at least nine cells 510. Each cell contains a matrix of graphic pixels (not shown). The number of pixels contained in each of the cells 510 depends on the graphic resolution of the image and the size of the cell. In the preferred embodiment, each of the cells 510 contains a 16-by-16 matrix of pixels. The cells 510 are identified as a plurality of vertical cell rows 520, each row containing three cells 510. A greater or lesser number of cells can be used to construct vertical stretch area 410. For convenience the cells have been numbered sequentially, from left to right, as numbers “1” through “9”. The outer boundary 115 of frame leg 119 is contained within cells 1, 4, and 7. The inner boundary 117 is contained within cells 3, 6, and 9. Cells 2, 5, and 8 are wholly contained within frame leg 119.

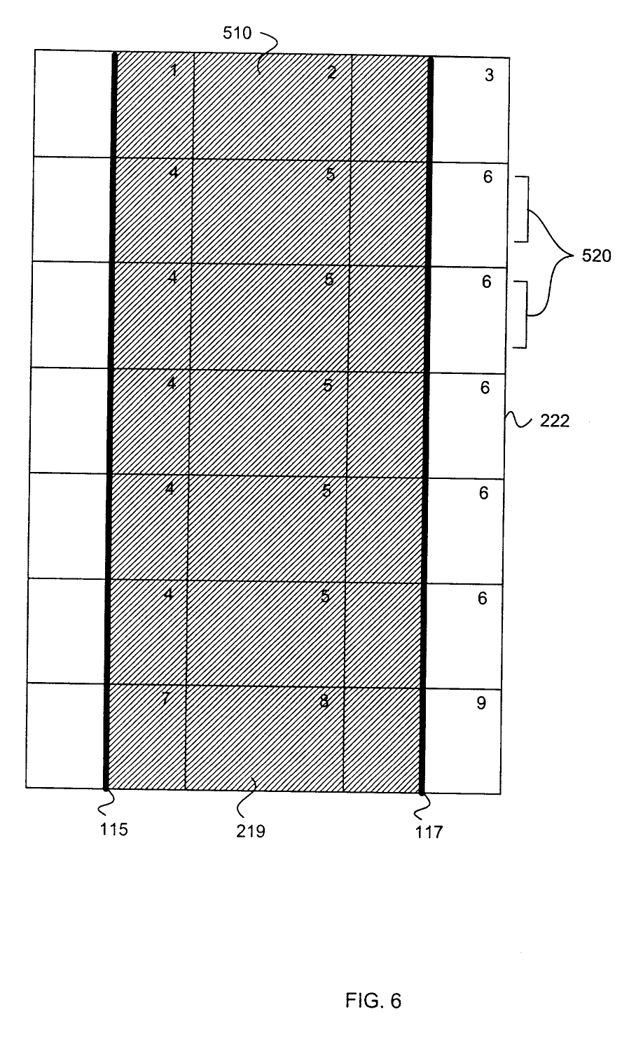

FIG. 6 is a graphical depiction the vertical stretch area 222 after stretching, as also shown in FIG. 2. Vertical stretch area 222 graphically depicts vertical stretch area 410 after it has been stretched in a vertical direction. Vertical stretch area 410 is stretched by adding additional vertical cell rows 520. More specifically, vertical stretch area 410 is stretched by inserting additional instances of the vertical cell row 520 containing cells 4, 5, and 6 between the vertical cell rows 520 containing cells 1, 2, and 3 and 7, 8, and 9. Thus, in a minimum configuration vertical stretch area 410 contains only a single cell row 520 containing cells 4, 5, and 6, as shown in FIG. 5. While in a stretched configuration vertical stretch area 222 contains five instances of cell row 520 containing cells 4, 5, and 6, as shown in FIG. 6. The vertical dimension of stretch area 410 can arbitrarily be increased by adding any number vertical cell rows 520 containing cells 4, 5, and 6. Since the vertical stretch area 410 was selected at an area of the graphic 100 where the frame leg 219 is straight, the addition of cell rows 520 does not require re-rendering of the graphic 100.

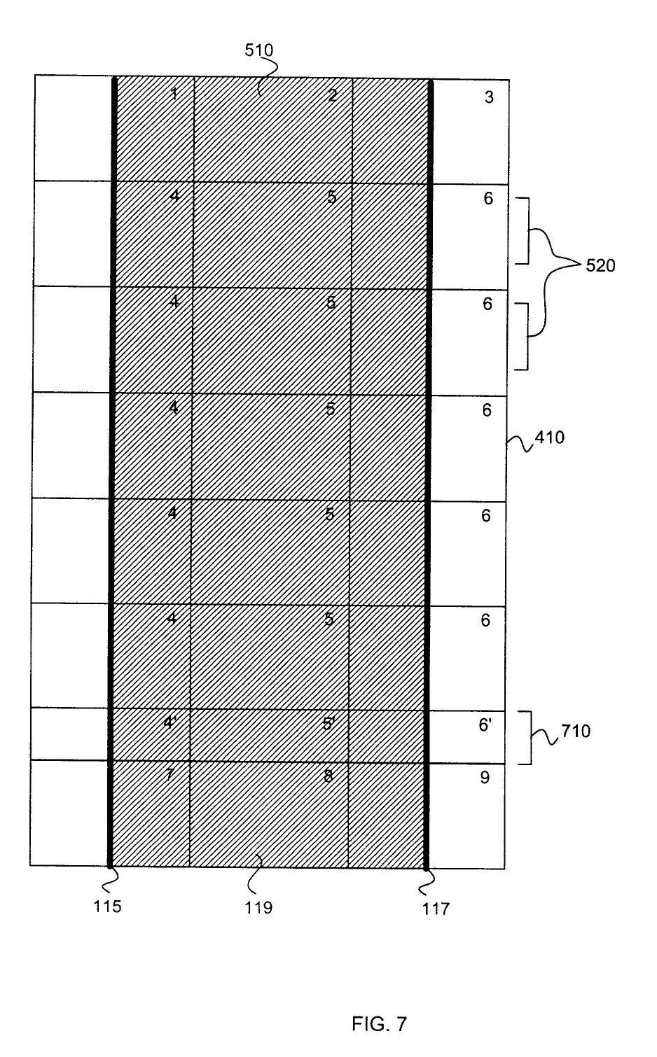

FIG. 7 is a graphical depiction of the vertical stretch area 222 containing a partial vertical row 710. When graphic 100 is stretched, the user points a mouse cursor to the resize handle 150 (FIG. 1) and drags the mouse cursor downward to enlarge the graphic in the vertical direction. By adding cells 4, 5, and 6 within cell rows 520, as discussed with reference to FIG. 6, the size of the graphic 100 can be stretched in full cell row increments of sixteen pixels. However, when full vertical cell rows 520 are used to stretch the graphic 100, users may notice a discontinuous or jumping effect as each vertical cell row is incrementally added during the image update interval. This incremental jumping can be significantly reduced by inserting partial vertical rows 710 instead. Partial vertical rows 710, denoted as cells 4′, 5′, and 6′, contain fewer than a full complement of pixels in a direction in which the graphic 100 is being stretched. Preferably, when the graphic 100 is stretched, a number of full cell rows 520 and partial cell rows 710 required is calculated. This number of full cell rows 520 and partial cell rows 710 are then inserted into the graphic 100 to create vertical stretch area 222. The partial row 710 size is variable and is set based on a number of pixels required to completely stretch the graphic 100 to its size determined during an image update interval.

For example, if, during an image update interval, the graphic 100 is stretched by a vertical distance equal to four and a half rows, then an initial vertical stretch area (such as vertical stretch area 410 shown in FIG. 5) is augmented by four full cell rows 510 and one partial cell row 710 having a size equal to one-half of a full cell row 510. Thus if a full cell row contains sixteen pixels in the vertical dimension, then the partial cell row will contain eight pixels in the vertical dimension. Subsequent adjustments in the stretch area in later image update intervals will result in a different number of full cell rows 410 and a different size for partial cell row 710.

Although selection of the partial row 710 pixels could follow some elaborate selection algorithm, the preferred method of pixel selection is to select rows of pixels from either end of a full vertical cell row 520, until a sufficient number of vertical rows are selected to create the partial row. In the example above, the partial row 710 contains half of the pixels from the full cell row 520 (either half produces an equivalent result).

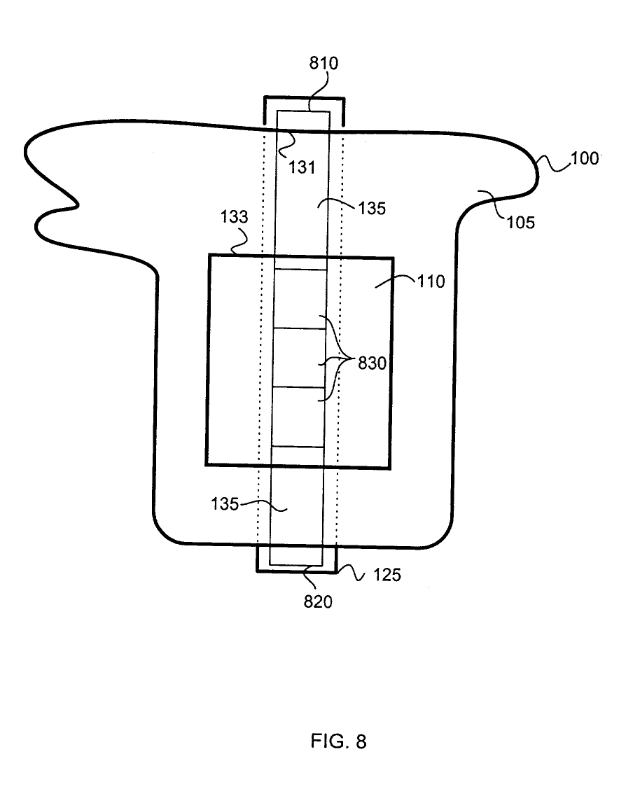

FIG. 8 is a graphical depiction of the graphic 100 including a more detailed horizontal resizable section 125. Horizontal resizable section 125 is divided into five horizontal stretch areas 810, 820, and 830. Horizontal stretch area 810 contains frame leg 135; the inner boundary 133 and the outer boundary 131 define this frame leg. Horizontal resizable section 125 contains three instances of horizontal stretch area 830. It should be noted that horizontal stretch areas 830 are the same as horizontal stretch areas 310, and have been renumbered to emphasize that the horizontal stretch areas 830 are in a minimum size configuration, while horizontal stretch areas 310 have been expanded, as is subsequently discussed. Horizontal stretch areas 830 contain the text region 110. Horizontal resizable section 125 further contains horizontal stretch area 820 which is parallel to and opposes horizontal stretch area 810, within the graphic 100. As with stretch area 810, stretch area 820 contains a frame leg 135.

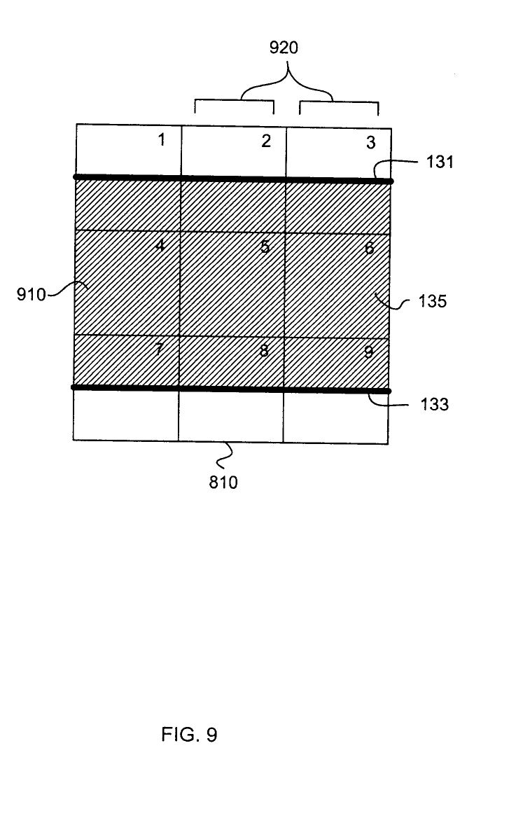

FIG. 9 is a graphical depiction of the horizontal stretch area 810 within the horizontal resizable section 125. Horizontal stretch area 810 includes frame leg 135, the frame leg being defined by the inner boundary 133 and the outer boundary 131. Horizontal stretch area 810 is divided into a matrix of nine grid cells 910. Each grid cell 910 contains a matrix of graphic pixels (not shown). The number of pixels contained in each grid cell 910 depends on the graphic resolution of the image and the size of the grid cell. In the preferred embodiment, each grid cell 910 contains a 16-by-16 matrix of grid cell pixels. The grid cells 910 are arranged in a sequence of grid columns 920, with each grid column consisting of three grid cells 910. It should be noted that a greater or lesser number of grid cells could alternately be used to construct the horizontal stretch area 810. For convenience the grid cells have been numbered sequentially, from left to right, with numbers “1” through “9”. The inner boundary 133 of frame leg 135 is contained within grid cells 7, 8, and 9. The outer boundary 131 is contained within grid cells 1, 2, and 3. Grid cells 4, 5, and 6 contain frame leg 135.

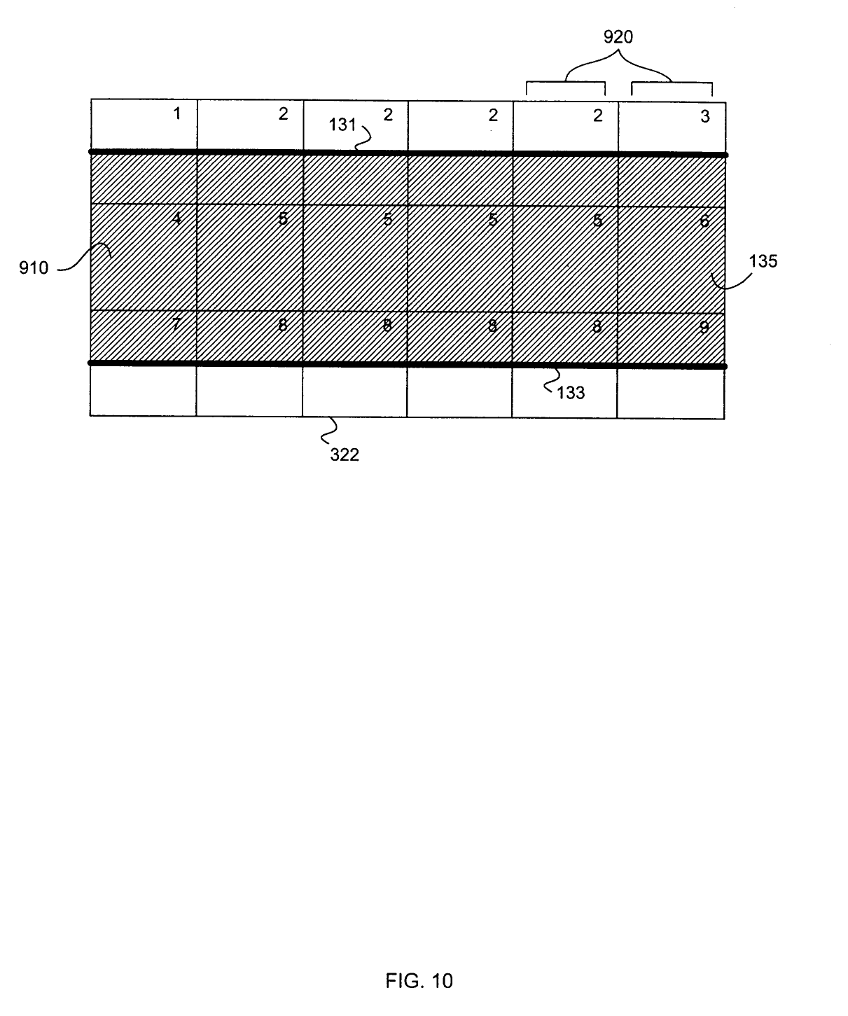

FIG. 10 is a graphical depiction the horizontal stretch area 322 after stretching, as shown in FIG. 3. The horizontal stretch area 322 contains six grid cell columns 920. Stretch area 322 is created by horizontally stretching stretch area 810 of FIG. 9. The horizontal enlargement to produce horizontal stretch area 322 is effected by adding additional grid cell columns 920. Specifically, in order to increase the horizontal dimension of the horizontal stretch area 810, additional instances of the grid cell column containing grid cells 2, 5, and 8 are added. In FIG. 9, horizontal stretch area 810 is shown with a single grid cell column 920 containing grid cells 2, 5, and 8; while in FIG. 10, four instances of the 2, 5, and 8 cell columns 920 are used to produce the horizontal stretch area 322. The horizontal dimension of horizontal stretch area 322 can arbitrarily be increased by adding any number of 2, 5, and 8 grid cell columns 920. Since the horizontal stretch area 810 was selected and the grid columns were added at an area of the graphic 100 where the frame leg 135 is straight, the graphic 100 need not be re-rendered.

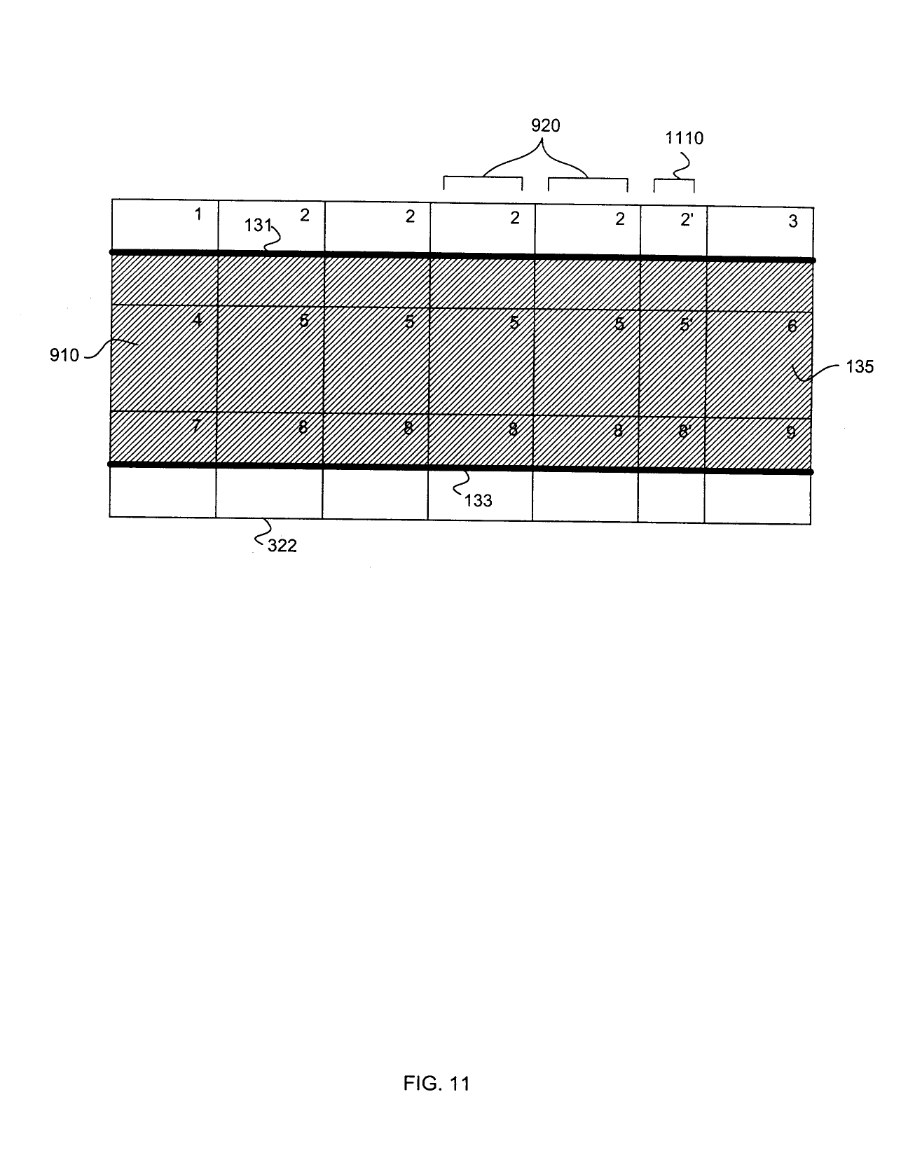

FIG. 11 is a graphical depiction of the horizontal stretch area 322 containing a partial horizontal column 1110. When graphic 100 is stretched, the user points a mouse cursor to the resize handle 150 (FIG. 1) and drags the mouse cursor downward to enlarge the graphic in the horizontal direction. By adding cells 2, 5, and 8 within grid columns 920, as discussed with reference to FIG. 10, the size of the graphic 100 can be stretched in full cell column increments of sixteen pixels. However, when full horizontal grid columns 920 are used to stretch the graphic 100, users may notice a discontinuous or jumping effect as each horizontal cell column is incrementally added during the image update interval. This incremental jumping can be significantly reduced by inserting partial horizontal grid columns 1110 instead. Partial horizontal grid columns I I 10, denoted as cells 2′, 5′, and 8′, contain fewer than a full complement of pixels in a direction in which the graphic 100 is being stretched. Preferably, when the graphic 100 is stretched, a number of full grid columns 920 and partial grid columns 1110 required is calculated. This number of full grid columns 920 and partial grid columns 1110 are then inserted into the graphic 100 to create horizontal stretch area 322. The partial grid columns 1110 size is variable and is set based on a number of pixels required to completely stretch the graphic 100 to its size determined during the image update interval.

For example, if the graphic 100 is stretched by a horizontal distance equal to three and a half columns, then an initial horizontal stretch area (such as horizontal stretch area 810 shown in FIG. 9) is augmented by three full cell grid columns 920 and one partial cell grid column 1110 having a size equal to one-half of a full cell grid column 910. Thus if a full cell grid column contains sixteen pixels in the horizontal dimension, then the partial cell column will contain eight pixels in the horizontal dimension. Subsequent adjustments in the stretch area in later image update intervals will result in a different number of full cell grid columns 920 and a different size for partial cell grid column 1110.

Although selection of the partial grid column 1110 pixels could follow some elaborate selection algorithm, the preferred method of pixel selection is to select columns of pixels from either end of a full horizontal cell grid column 920, until a sufficient number of horizontal columns are selected to create the partial column. In the example above, the partial grid column 1110 contains half of the pixels from the full cell grid column 920 (either half produces an equivalent result).

Note that the graphic 100 can be reduced in size in either a vertical or horizontal dimension by reversing the above processes, whereby cells are removed from the stretch areas instead of being added.

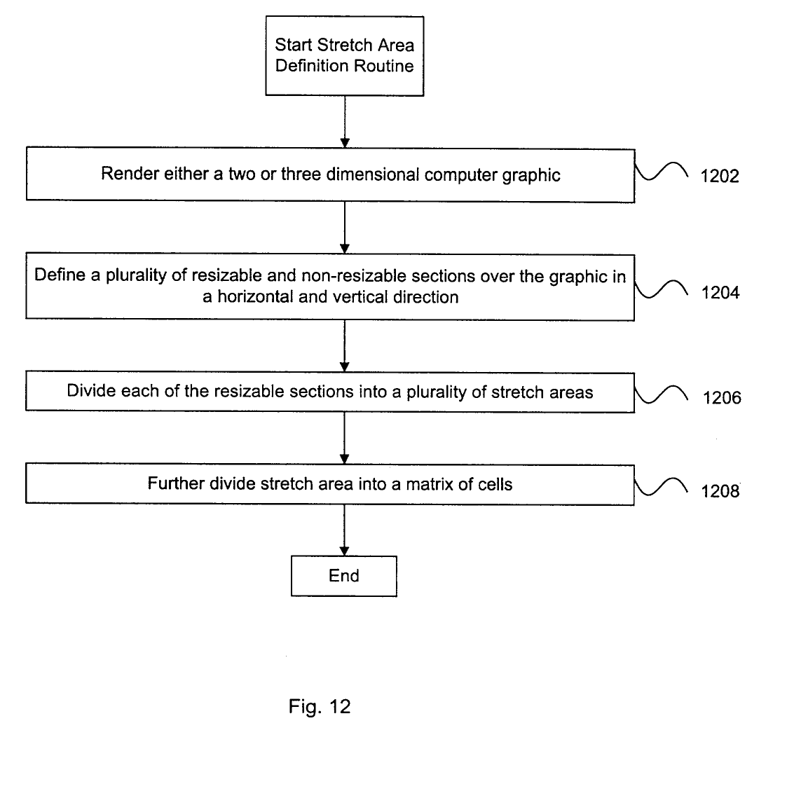

FIG. 12 is a flowchart for defining stretch areas in multi-dimensionally rendered graphical images. The method is implemented by conventionally available computer equipment. The method begins in step 1202 where either a two or three dimensional computer graphic 100 is rendered in a conventional manner. Next, in step 1204, a plurality of resizable and non-resizable sections is defined over the graphic 100 in a horizontal and a vertical direction. In step 1206, each of the resizable sections is divided into a plurality of stretch areas. The stretch areas are further divided in to a matrix of cells, in step 1208.

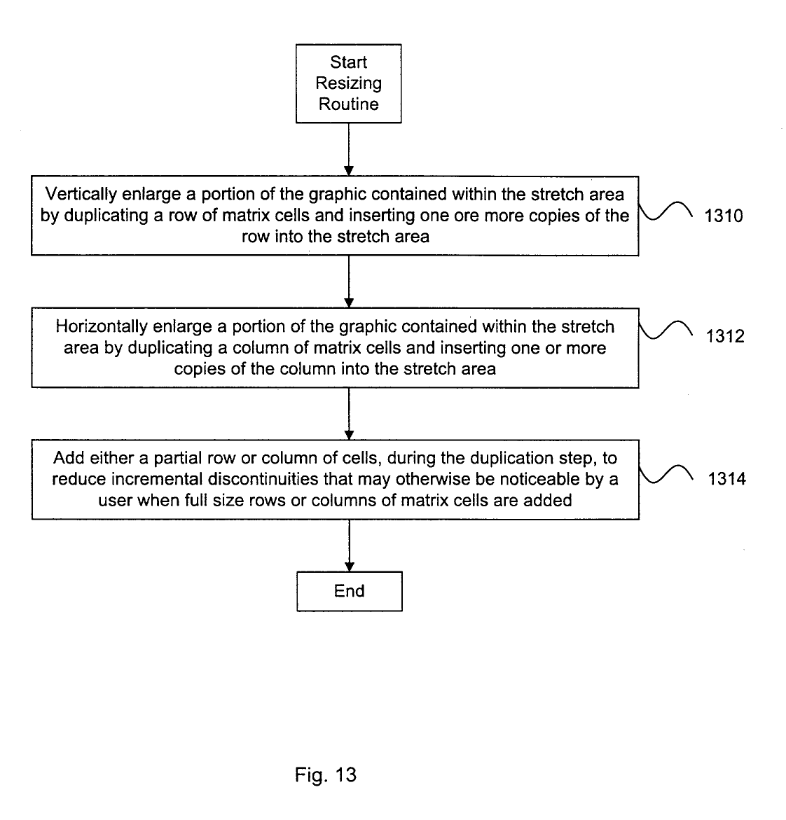

FIG. 13 is a flowchart for resizing multi-dimensionally rendered graphical images. Like the method of FIG. 12, this method is also implemented by conventionally available computer equipment. The method begins in step 1310, where a portion of the graphic 100 contained within the stretch area is vertically enlarged by duplicating a row of matrix cells and inserting the row into the stretch area. In step 1312, a portion of the graphic 100 contained within the stretch area is horizontally enlarged by duplicating a column of matrix cells and inserting the column into the stretch area. Next, in step 1314, either a partial row or column of cells is added to the graphic 100, during the duplication step, to reduce incremental discontinuities that may otherwise be noticeable by a user when full size rows or columns of matrix cells are added. After step 1314, the process of resizing is complete. The resizing process described above can be repeated in later image update intervals as the user drags the resize handle 150 (FIG. 1).

While the present invention has been described with reference to a preferred embodiment, those skilled in the art will recognize that various modifications may be made. Variations upon and modifications to the preferred embodiment are provided by the present invention, which is limited only by the following claims.

What is claimed is:

1. A method for resizing multi-dimensionally rendered graphical images, comprising the steps of:
rendering a computer graphic;
dividing the computer graphic into a cell matrix;
duplicating a predetermined subset of the cell matrix to create a duplicated subset; and
inserting the duplicated subset into the cell matrix.

2. The method of claim 1 further comprising the step of defining cell rows within the cell matrix.

3. The method of claim 2 wherein the duplicating step includes the step of duplicating a cell row to create a duplicated cell row.

4. The method of claim 3 wherein the inserting step includes the step of inserting the duplicated cell row next to one of the cell rows.

5. The method of claim 1 further comprising the step of defining full-size cell rows within the cell matrix.

6. The method of claim 5 wherein the duplicating step includes the steps of:
duplicating a full-size cell row to create a duplicated full-size cell row; and
dividing the duplicated full-size cell row into partial cell rows.

7. The method of claim 6 wherein the inserting step includes the step of inserting a partial cell row next to one of the full-size cell rows.

8. The method of claim 1 further comprising the step of defining cell columns within the cell matrix.

9. The method of claim 8 wherein the duplicating step includes the step of duplicating a cell column to create a duplicated cell column.

10. The method of claim 9 wherein the inserting step includes the step of inserting the duplicated cell column next to one of the cell columns.

11. The method of claim 1 further comprising:
the step of defining full-size cell columns within the cell matrix; and
wherein the duplicating step includes the steps of,
duplicating a full-size cell column to create a duplicated full-size cell column; and
dividing the duplicated full-size cell column into partial cell columns.

12. The method of claim 11 wherein the inserting step includes the step of inserting a partial cell column next to one of the full-size cell columns.

13. A system for resizing multi-dimensionally rendered graphical images, comprising:
means for rendering a computer graphic;
means for dividing the computer graphic into a cell matrix;
means for duplicating a predetermined subset of the cell matrix to create a duplicated subset; and
means for inserting the duplicated subset into the cell matrix.

14. The system of claim 13 further comprising means for defining cell rows within the cell matrix.

15. The system of claim 14 wherein the means for duplicating includes means for duplicating a cell row to create a duplicated cell row.

16. The system of claim 15 wherein the means for inserting includes means for inserting the duplicated cell row next to one of the cell rows.

17. The system of claim 13 further comprising:
means for defining full-size cell rows within the cell matrix; and
wherein the means for duplicating includes,
means for duplicating a full-size cell row to create a duplicated full-size cell row; and
means for dividing the duplicated full-size cell row into partial cell rows.

18. The system of claim 17 wherein the means for inserting includes means for inserting a partial cell row next to one of the full-size cell rows.

19. The system of claim 13 further comprising means for defining cell columns within the cell matrix.

20. The system of claim 19 wherein the means for duplicating includes means for duplicating a cell column to create a duplicated cell column.

21. The system of claim 20 wherein the means for inserting includes means for inserting the duplicated cell column next to one of the cell columns.

22. The system of claim 13 further comprising:
means for defining full-size cell columns within the cell matrix; and
wherein the means for duplicating includes,
means for duplicating a full-size cell column to create a duplicated full-size cell column; and
means for dividing the duplicated full-size cell column into partial cell columns.

23. The system of claim 22 wherein the means for inserting includes means for inserting a partial cell column next to one of the full-size cell columns.

24. A computer-useable medium embodying computer program code for causing a computer to resize multi-dimensionally rendered graphical images by performing the steps of:
rendering a computer graphic;
dividing the computer graphic into a cell matrix;
duplicating a predetermined subset of the cell matrix to create a duplicated subset; and
inserting the duplicated subset into the cell matrix.

25. The computer-useable medium of claim 24 further performing the step of defining cell rows within the cell matrix.

26. The computer-useable medium of claim 25 wherein the duplicating step includes the step of duplicating a cell row to create a duplicated cell row.

27. The computer-useable medium of claim 26 wherein the inserting step includes the step of inserting the duplicated cell row next to one of the cell rows.

28. The computer-useable medium of claim 24 further performing the step of defining full-size cell rows within the cell matrix; and
wherein the duplicating step includes the steps of,
duplicating a full-size cell row to create a duplicated full-size cell row; and
dividing the duplicated full-size cell row into partial cell rows.

29. The computer-useable medium of claim 28 wherein the inserting step includes the step of inserting a partial cell row next to one of the full-size cell rows.

30. The computer-useable medium of claim 24 further performing the step of defining cell columns within the cell matrix.

31. The computer-useable medium of claim 30 wherein the duplicating step includes the step of duplicating a cell column to create a duplicated cell column.

32. The computer-usable medium of claim 31 wherein the inserting step includes the step of inserting the duplicated cell column next to one of the cell columns.

33. The computer-useable medium of claim 24 further performing the step of defining full-size cell columns within the cell matrix; and
wherein the duplicating step includes the steps of,
duplicating a full-size cell column to create a duplicated full-size cell columns; and
dividing the duplicated full-size cell column into partial cell columns.

34. The computer-useable medium of claim 33 wherein the inserting step includes the step of inserting a partial cell column next to one of the full-size cell columns.

35. A system for resizing multi-dimensionally rendered graphical images, the apparatus comprising:
an internal memory for storing computer instructions which, render a computer graphic, divide the computer graphic into a cell matrix, duplicate a predetermined subset of the cell matrix to create a duplicated subset, and insert the duplicated subset into the cell matrix; and
a processing unit coupled to the internal memory for executing the computer instructions stored with the internal memory.

36. The system of claim 35 wherein the internal memory further stores computer instructions which define cell rows within the cell matrix.

37. The system of claim 36 wherein the internal memory further stores computer instructions to duplicate a cell row to create a duplicated cell row.

38. The system of claim 37 wherein the internal memory further stores computer instructions to insert the duplicated cell row next to one of the cell rows.

39. The system of claim 35 wherein the internal memory further stores computer instructions which define full-size cell rows within the cell matrix, duplicate a full-size cell row to create a duplicated full-size cell row, and divide the duplicated full-size cell row into partial cell rows.

40. The system of claim 39 wherein the internal memory further stores computer instructions to insert the partial cell row next to one of the full-size cell rows.

41. The system of claim 35 wherein the internal memory further stores computer instructions which define cell columns within the cell matrix.

42. The system of claim 41 wherein the internal memory further stores computer instructions to duplicate a cell column.

43. The system of claim 42 wherein the internal memory further stores computer instructions to insert the duplicated cell column next to one of the cell columns.

44. The system of claim 35 wherein the internal memory further stores computer instructions which define full-size cell columns within the cell matrix, duplicate a full-size cell column to create a duplicated full-size cell column, and divide the duplicated full-size cell column into partial cell columns.

45. The system of claim 44 wherein the internal memory further stores computer instructions which insert the partial cell column next to one of the full-size cell columns.
